(19) United States
(12) Patent Application Publication
(10) Pub. No.: US 2012/0183802 A1
(43) Pub. Date: Jul. 19, 2012

(54) RESISTANCE WELD ADDITIVE MANUFACTURING

(76) Inventor: Gerald J. Bruck, Oviedo, FL (US)

(21) Appl. No.: 13/005,674

(22) Filed: Jan. 13, 2011

(51) Int. Cl. B32B 15/00; B23K 11/00

(52) U.S. Cl. 428/609; 219/117.1; 428/615

(57) ABSTRACT

A method of additive manufacturing, including resistance welding together contacting surfaces of adjacent substrate sheets, wherein weld nuggets overlap adjacent weld nuggets and collectively form a respective layer that bonds a portion of an entirety of an area of the respective contacting surfaces, thereby forming an assembled structure of at least three substrate sheets, wherein each substrate sheet includes a respective portion of a final structure.

### FIELD OF THE INVENTION

The invention relates to a method of additive manufacturing. Specifically, the invention relates to resistance welding multiple layers of substrate material together to form an assembled structure.

### BACKGROUND OF THE INVENTION

Additive manufacturing is generally considered the buildup of three dimensional objects by multiple layer processing, each layer representing a portion of the three dimensional object. Multiple additive manufacturing processes are in use, including stereo lithography. In stereo lithography light, (i.e. often a laser beam) is programmed to traverse a liquid that cures and becomes solid when exposed to the laser wavelength, each pass of the laser representing one layer. Certain photopolymers are most often used for this.

The three dimensional object may also be produced directly by energy sources of high enough power to melt a metal or alloy used in the three dimensional object. For example, high power laser beams are commonly used in a manner similar to stereo lithography, where the laser sinters or fuses metal layer by layer. These processes include laser sintering, direct metal laser sintering, laser engineered net shape, etc. Another technique is called electro-spark deposition, where an electric discharge causes melting and transfer of small amounts of electrode material to deposit and splat on the substrate. The process builds up an object after many minute layers are processed.

The above-described processes have disadvantages and limitations. For example, some of the processes are exceedingly slow and cost prohibitive if many parts are required. Further, except for parts where sintered powder deposits result in adequate material properties, deposition of metal by these processes usually requires complete remelting and solidification. Such remelting degrades the properties of many alloys. The properties and geometry of the underlying substrate are also negatively affected by the heat of subsequent layered processing. Also, certain alloys are available only as a thin sheet because they require specific environmental heat treatment to optimize properties, and as such, providing the alloy in powder form as required for the above processes is not possible.

A more recent process is called ultrasonic additive manufacturing, or ultrasonic consolidation. In this process three-dimensional objects are built from CAD definitions of slices of the object. Foils of thickness representing these slices are sequentially bonded on each other using pressure and ultrasonic energy (oscillations between the parts to be joined). The frictional energy bonds the parts without melting in what may be thought of as micro-forging. Then the part is final machined to required dimension.

Ultrasonic consolidation avoids the melting of the deposited material and many of the drawbacks of the above processes, but it has its own limitations. For example, available power limits the process to soft alloys (e.g. aluminum). Available tool forces and available tool rigidity limit accuracy of fabrication. Tools are of limited durability; in particular sonotrode wear is high. Material is often transferred to the sonotrode, causing maintenance issues and yield losses. Finally, a thickness of deposited material is limited to a “ribbon” typically of 0.15 mm (0.006″) thickness, and therefore the process is slow and often involves incremental machining steps. Consequently, there remains room in the art for improvement to additive manufacturing techniques.

### BRIEF DESCRIPTION OF THE DRAWINGS

The invention is explained in the following description in view of the drawings that show:

FIG. 1 shows a top view of the formation of an assembled structure at the completion of the assembly process.

FIG. 2 is a side view of the assembled structure of FIG. 1.

FIG. 3 is an end view of the assembled structure of FIG. 2.

FIG. 4 is an end view of an assembled structure composed of non-flat sheets and bonded to another object.

### DETAILED DESCRIPTION OF THE INVENTION

The present inventor has devised an innovative, yet simple, additive manufacturing process that is not subject to many of the limitations of conventional additive manufacturing techniques. The process uses resistance welding to join multiple layers of a substrate where each layer of the substrate forms a portion of an assembled structure. The assembled structure may be the final structure, or may be subject to subsequent machining to become a final structure.

Individual layers may be fabricated using conventional cutting processes, (e.g. milling, sawing, water jet, plasma, electro spark discharge etc) prior to being assembled, but any fabricating technique is acceptable. Each pre-assembled layer may be fabricated to a layer final shape such that no subsequent machining will be required, or it may be fabricated to a layer assembly shape in anticipation of subsequent machining of the assembled structure to reach a final structure.

Resistance welding involves straddling two articles, such as layers, with electrodes, applying pressure to cause intimate contact between abutting surfaces, and then generating an electrical current. Resistance at the faying surfaces (i.e. surfaces of the substrate to be welded) causes local, superficial melting, which subsequently solidifies into a “nugget” that bonds the surfaces. The bond in the process disclosed herein results from weld nuggets that may or may not overlap adjacent nuggets to form a bonding layer between abutting (i.e. contacting) portions of surfaces of adjacent substrate sheets. Any resistance welding process may be used, including seam, spot, or projection. An aspect of the process is minimal melting of the substrate, (i.e. only local), which leaves the majority of the substrate unmelted, and thus the majority of the substrate retains desired properties that may otherwise be degraded by alternate welding processes.

The bond in the process is formed via repetitions of any of the resistance welding processes. For example, in a seam welding process, electrode welding wheels sandwich the material to be welded in between them, and electricity is periodically applied. Each time the electricity is applied a weld nugget is formed, bonding the two materials. The electricity is applied frequently enough that each weld nugget overlaps the one before it in the band (i.e. seam), thereby forming a continuous band, along the direction of travel of the weld wheels. A second band may be formed adjacent to a first band such that the edges of the bands overlay, and thus the two bands would form a new band of approximately twice the width. In an embodiment this process is repeated until an entire area of contacting portions of surfaces between adjacent substrates has been bonded. In other words, weld nuggets form a layer that bonds the entirety of abutting portions of adjacent substrate surfaces. In that embodiment there are no gaps present between abutting portions of adjacent substrate surfaces; the bond coverage is complete. In an alternate embodiment, the bond coverage is less than 100%. For example, there may be spaces between adjacent seams in a weld seam, or adjacent nuggets in spot or projection resistance welds, such that contacting portions of adjacent surfaces are bonded with a bonding layer that may form a weld pattern. A pattern to the weld need not be present, however, so long as contacting portions of adjacent layers are welded to each other with sufficient strength, which is determined by the requirements of the final structure. A thickness of the material layer may vary from one layer to another, as may the chemical composition of the material.

Turning to the drawings, FIG. 1 shows a top view of the formation of an assembled structure 10 at the completion of the assembly process. The top weld wheel 18 and bottom weld wheel 20 surround an assembled structure 10 made of three layers; a first layer 12, a second layer 14, and a third layer 16. However, it is envisioned that assembled structures may include many layers, with three being a minimum. Each layer may be different from any or all other layers in any or all of size, shape, material, and thickness etc. For instance, the first layer 12 may be larger than the second layer 14, which may in turn be larger than the third layer 16. However, the relationships may vary in that any layer may be either larger or smaller than any other layer, regardless of position in the assembled structure. The layers 12, 14, 16 may vary in shape from each other as shown by the unique shape of the third layer 16.

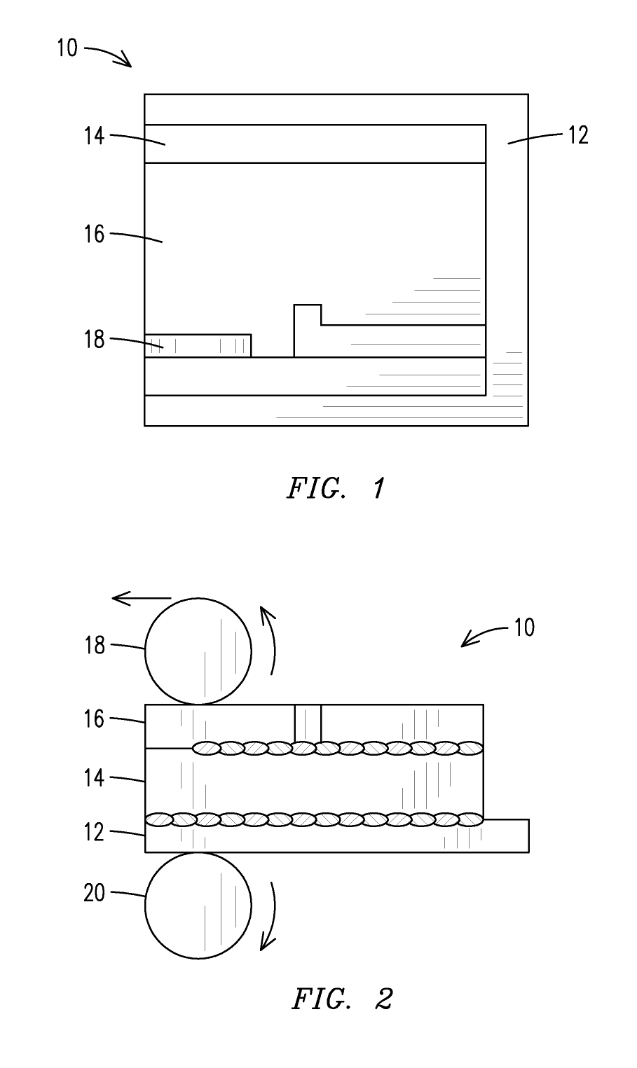

FIG. 2 is a side view of the assembled structure 10 with the first layer 12, the second layer 14, and the third layer 16. The top wheel 18 and bottom weld wheel 20 are shown completing a final weld band between the second layer 14 and the third layer 16, thereby completing the assembled structure 10. Second layer 14 is shown as being thicker than the other layers, though any layer may be thicker or thinner than any other layer, regardless of its position within the assembled structure 10. The layers 12, 14, 16 may also vary in material from any or all of the other layers. For example, an outer layer of a final structure may be a different material than other layers to provide different properties.

In order to weld dissimilar thickness and/or dissimilar materials, a top weld wheel face area and a bottom weld wheel face area (i.e. a face area of the electrodes) and weld wheel material electrical resistance (i.e. electrode material electrical resistance) can be adjusted to improve heat balance for such situations. For example, in an embodiment the first layer 12 and the third layer 16 are of equal thickness and the second layer 14 is thicker than the first layer 12 and the third layer 16, and the materials in the layers 12, 14, 16 are the same. After the first layer 12 and the second layer 14 are resistance welded, the third layer 16 would be resistance welded to the workpiece made of the assembled first layer 12 and second layer 14, which has a thickness of the first layer 12 and the second layer 14 together. The thicker workpiece represents higher resistance than the third (single thickness) layer 16. Applying a larger weld wheel face area to the workpiece (i.e. first layer 12 and the second layer 14 together) would then help concentrate current density to the third layer 16 and help balance the heat—thereby shifting the nugget toward the third layer 16. A fourth layer could then be added to the then-welded three thickness substrate (assembly 10) by similar subsequent increase in weld wheel face area in contact with the assembly 10. Other techniques to balance heat as layers are added include increasing weld time to more uniformly distribute heat and adjusting pulsing currents and times. Differing layer material can be addressed with similar techniques—treating higher resistance material as one would treat thicker materials. For example, copper beryllium may be resistance welded to steel alloys of higher resistivity by using relatively small weld wheel face area on the copper beryllium side of the joint.

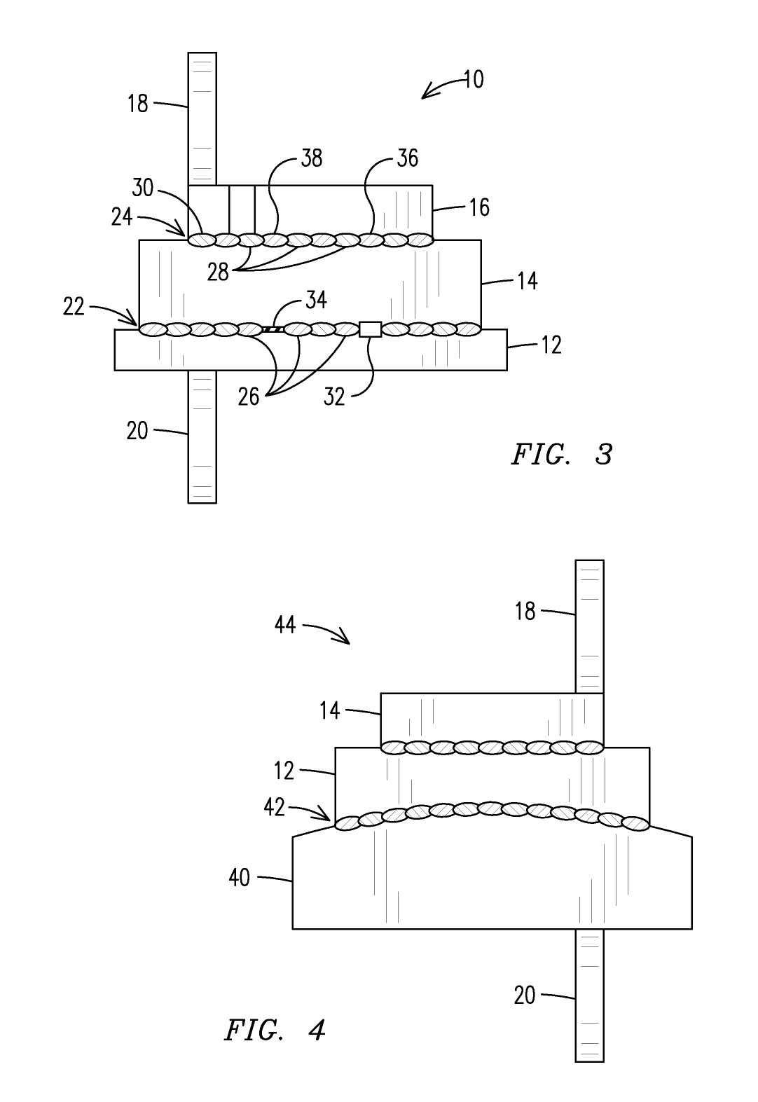

FIG. 3 is an end view of the assembled structure of FIG. 2. Top weld wheel 18 and bottom weld wheel 20 apply pressure to the top and bottom of the assembled structure 10 respectively such that contacting surfaces to be resistance welded are in intimate contact with each other. Electricity is applied through the top weld wheel 18 and bottom weld wheel 20 and a nugget is formed at an interface of the surfaces. A first bonding layer 22 has been formed via the seam welding process between the first layer 12 and the second layer 14, and is composed of first layer nuggets 26. First layer nuggets 26 overlap each other to form the first bonding layer 22. A second bonding layer 24 composed of second layer nuggets 28 is being completed between the second layer 14 and the third layer 16, as the seam welding process completes a final weld band 30. As can be seen, the first layer nuggets 26 form continuous bands (each band extends in a direction into the paper, i.e. along the direction of travel of the weld wheels) that may overlap each other. In an embodiment, since each weld band is continuous, and each weld band may overlap adjacent weld bands to form the bonding layer, the bonding layer may be continuous. Alternately, the weld bands or weld nuggets 26, 28 may not overlap each other, resulting in a bonding layer 22, 24 where less than 100% of the contacting surfaces are joined by weld nuggets 26, 28, as discussed below.

Also visible in FIG. 3 is a channel 32 between the first layer 12 and the second layer 14. Such a channel 32 can be formed by ensuring the surfaces of adjacent layers do not contact each other where the channel is to be formed. This can be accomplished by, for example, machining a recess into either or both of the layers where the channel 32 is to be formed. When such a recess is formed, the surfaces of the adjacent layers are not abutting (i.e. contacting) each other, and thus a weld will not be formed there, leaving a channel 32 in the assembled structure 10. Seam welding for example, the second layer 14 to the third layer 16 at a first point 36 above the channel 32 is possible despite the presence of the channel 32 being between the first point 36 and the bottom wheel 20 when the first point 36 is being resistance welded. This is because the electricity may simply travel around the channel 32 due to the presence of the first bonding layer 22 adjacent the channel 32 which can conduct the electricity from the resistance welding process, thereby forming a weld at the first point 36, which experiences sufficient pressure to form the second layer nugget 28. Such a channel can be formed for a myriad of reasons, including for cooling channels throughout an assembled structure 10, or simply to reduce the amount of first layer nuggets 26 necessary to complete the first bonding layer 22, which in turn reduces production time.

In addition to channels 32, the formation of weld nuggets 26, 28 can be prevented where they are not wanted by placing an weld preventing material 34 between surfaces of adjacent layers to prevent them from abutting (i.e. contacting). Where the weld preventing material 34 is an electrical insulator a weld nugget 26 will not form because no current can pass through the interface. Alternately, when the weld preventing material 34 is an appropriate electrical conductor the interface will not heat and form a weld nugget because the current path will have less resistance than a simple interface would. Similar to the channel 32 above, a weld nugget 28 at a second point 38 above the weld preventing material 34 may form despite the presence of the weld preventing material 34 between the second point 38 and the bottom wheel 20 because the electricity may simply travel around the weld preventing material 34 and through adjacent portions of the bonding layer 22. Such weld preventing material 34 may be any material, such as Teflon® when an electrical insulator is desired, or any other suitable material. Depending on the requirements of the finished structure, the weld preventing material 34 may remain in place or may be removed subsequent to the resistance welding step. Removal can be accomplished by melting the weld preventing material 34, chemical leaching, or any other technique known to those in the art.

The assembled structure 10 shown is composed of three layers, but any number of layers is possible in any configuration. When more than three layers are used, the process is simply a matter of repeating the step of bonding an additional layer to the sub assembly containing previously bonded layers. The only requirement is that the layers must be configured such that a bonding layer can be formed via a resistance welding process. The resistance welding process is shown as seam welding, but spot welding or projection welding are also envisioned, with the same requirement as for seam welding. Furthermore, the process is not limited to additive manufacturing, but is intended to encompass rapid prototyping as well.

As shown in FIG. 4, the sheets need not be flat, but instead may be, for example, curved. Furthermore, the assembled structure may be bonded to another object, for example as part of a more complex assembly process, or a repair process. In an embodiment such as shown in FIG. 4, a first sheet 12 may first be bonded to an other object 40, such as by but not limited to the resistance welding technique disclosed herein to form an adhering layer 42 between the first sheet 12 and the other object 40, and then the bonding of the second layer 14 to the first layer 12, and any subsequent layers, continues as described above. As a result of this embodiment a complex structure 44 may be formed where the complex structure 44 includes an assembled structure that may or may not require further machining. Alternately, an other object 40 may be repaired using this technique. For example, a portion of the object may be excavated and replaced with such an assembled structure.

The process provides advantages not present in conventional additive manufacturing methods. For example, this method utilizes known forming processes and known welding processes to produce an assembled structure. Hence, incorporating this process may require minimal investment of time and money. The assembled structure does not require any additional heat treatment because the majority of the substrate is not melted in the process, and the unmelted majority may possess sufficient properties required in the final structure. As a result there would be no need to perform a post-process final heat treatment, a further time and money saving advantage.

Many of the above processes require the raw material be in powder form. However, certain materials are not available in powder form. For example, Haynes NS-163® alloy, manufactured by Haynes International of Kokomo, Ind., is a desirable material but is only available in thin sheets because the material requires specific environmental heat treatment to optimize properties. Specifically, NS-163® alloy is precipitation strengthened during a heat treatment in an atmosphere containing nitrogen. During the heat treatment the nitrogen in the atmosphere is incorporated into the NS-163® alloy and forms nitrides with the titanium and niobium present in the NS-163® alloy. These nitrides are precipitates that strengthen the material, but this strengthening effect may be reduced or eliminated when a strengthened substrate is melted, such as during any subsequent welding process. The additive manufacturing process disclosed herein only locally melts a small portion of the substrate to form a nugget during the joining process. As a result this process can utilize already-strengthened NS-163® alloy, and any similar material whose properties may be degraded during a weld process, with minimal degradation of properties due to welding, to produce a full interface bond. In addition, should it be desired, the additive manufacturing process could be performed in an atmosphere favorable for the substrate. For example, in the case of NS-163® alloy, the process could be performed in a nitrogen atmosphere so the nugget could have access to nitrogen that may help re-strengthen the weld in a manner similar to the strengthening process that occurs during the heat treatment process. Consequently, the process disclosed herein permits the use of NS-163® alloy and any other material whose properties may be destroyed by a welding process or that may not be available in powder form, which is otherwise not possible using conventional techniques.

The present process provides additional flexibility not yet seen in the art. This process enables processing of substantially thicker substrate sheets than in other processes, and a wider range of materials may be bonded. For example, in ultrasonic consolidation the material is typically limited to aluminum alloys, of 0.15 mm (0.006″) thickness. Resistance welding is not limited to aluminum alloys or to such thin materials. As a result, not only is a wider range of materials available, but when using thicker sheets process time will be reduced. Additionally, tool wear such as occurs in ultrasonic consolidation is not a concern with this process. The instant process provides all of these advantages with minimal investment, and as such represents a substantial improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of additive manufacturing, comprising resistance welding together contacting surfaces of adjacent substrate sheets, wherein weld nuggets overlap adjacent weld nuggets and collectively form a respective layer that bonds an entire area of the respective contacting surfaces, thereby forming an assembled structure comprising at least three substrate sheets, wherein each substrate sheet comprises a respective portion of a final structure.

2. The method of claim 1, comprising machining the assembled structure to form the final structure.

3. The method of claim 1, comprising resistance welding entire abutting surfaces of one substrate sheet and an other object to produce another continuous layer bonding the one substrate sheet to the other object.

4. The method of claim 1, wherein the assembled structure comprises at least two different materials.

5. The method of claim 1, wherein a thickness of at least one substrate sheet is different than a thickness of another substrate sheet.

6. The method of claim 4, comprising adjusting at least one parameter selected from a group consisting of electrode face area, electrode resistance, weld time, pulse duration, and pulse current to control a location of nugget formation.

7. The method of claim 1, comprising forming at least one substrate sheet into a non-flat shape.

8. The method of claim 1, comprising performing resistance welding in an atmosphere comprising an active gas, wherein at least one substrate sheet comprises a gas reactive alloy.

9. The method of claim 1, wherein the final structure comprises a channel between the adjacent layers.

10. An apparatus formed using the method of claim 1.

11. A method of fabricating a three dimensional metallic final structure, comprising:
creating a digital model of an assembled structure;
defining layers of the assembled structure in the digital model representing respective portions of the assembled structure;
fabricating a substrate sheet corresponding to each layer of the assembled structure;
resistance welding a first of the substrate sheets to a second of the substrate sheets to form a first assembly;
resistance welding a third of the substrate sheets to the first assembly to form a second assembly; and
repeating the steps of resistance welding substrate sheets to formed assemblies until the assembled structure is formed.

12. The method of claim 10, comprising resistance-welding 100% of abutting surfaces of adjacent layers by overlapping adjacent weld nuggets.

13. The method of claim 10, comprising disposing a weld preventing material between a portion of abutting surfaces of adjacent layers to prevent weld nugget formation in the portion.

14. The method of claim 13, comprising removing the weld preventing material from the final structure.

15. The method of claim 10, wherein the final structure comprises a channel between adjacent layers.

16. The method of claim 10, comprising machining the assembled structure to form a final structure.

17. The method of claim 10, comprising generating substrate sheets wherein at least one substrate sheet comprises a gas reactive alloy and resistance welding in an atmosphere comprising a reactive gas.

18. The method of claim 10, comprising resistance welding one substrate sheet and to an other object.

19. The method of claim 10, comprising forming at least one substrate sheet into a non-flat shape.

20. An apparatus formed using the method of claim 10.
